(19) United States
(12) Patent Application Publication
(10) Pub. No.: US 2026/0321680 A1
(43) Pub. Date: Oct. 15, 2026

(54) METHODS OF MAKING SOLID OXIDE ELECTROCHEMICAL CELLS USING LOW SINTERING TEMPERATURES

(71) Applicant: Bloom Energy Corporation, San Jose, CA (US)

(72) Inventors: Dalton COX, Oakland, CA (US); Emad EL BATAWI, Aurora, CO (US)

(21) Appl. No.: 19/638,624

(22) Filed: Apr. 3, 2026

Related U.S. Application Data
(60) Provisional application No. 63/785,906, filed on Apr. 9, 2025.

(51) Int. Cl. H01M 4/90; H01M 4/88; H01M 8/12; H01M 8/1213

(52) U.S. Cl. CPC H01M 4/9066; H01M 4/8828; H01M 4/8885; H01M 8/1213; H01M 2008/1293

(57) ABSTRACT

A method of forming a fuel electrode supported or co-supported solid oxide electrochemical cell includes depositing a fuel electrode functional layer containing a nickel containing phase and a doped ceria ceramic phase over a fuel electrode support, depositing an electrolyte layer comprising a ytterbia-ceria-scandia-stabilized zirconia (YbCSSZ) material over the fuel electrode functional layer, sintering the electrolyte layer at temperature below 1300 °C, and forming an air electrode on the electrolyte layer.

### FIELD

The embodiments of the present disclosure are generally directed to solid oxide electrochemical cells and more specifically to methods of making solid oxide electrochemical cells using low sintering temperatures.

### BACKGROUND

Electrochemical cells include solid oxide fuel cells (SOFCs) and solid oxide electrolyzer cells (SOECs). Electrochemical cell systems may include one or more stacks including electrochemical cells separated by interconnects.

### SUMMARY

According to various embodiments of the present disclosure, a method of forming a fuel electrode supported or co-supported solid oxide electrochemical cell includes depositing a fuel electrode functional layer containing a nickel containing phase and a doped ceria ceramic phase over a fuel electrode support, depositing an electrolyte layer comprising a ytterbia-ceria-scandia-stabilized zirconia (YbCSSZ) material over the fuel electrode functional layer, sintering the electrolyte layer at temperature below 1300 °C, and forming an air electrode on the electrolyte layer.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1A is a perspective view of an electrochemical cell column, FIG. 1B is a perspective view of one solid oxide electrochemical cell stack included in the column of FIG. 1A, and FIG. 1C is a side cross-sectional view of a portion of the stack of FIG. 1B.

FIG. 2A is a top view of the air side of an interconnect of the stack of FIG. 1B, and FIG. 2B is a top view of the fuel side of the interconnect.

FIG. 3A is a perspective view of a cross flow electrochemical cell stack, FIG. 3B is an exploded perspective view of a portion of the stack of FIG. 3A, FIG. 3C is a top view of the fuel side of an interconnect included in the stack of FIG. 3A, and FIG. 3D is a schematic view of an electrochemical cell included in the stack of FIG. 3A.

FIG. 4A is a cross-sectional view of a fuel electrode supported electrochemical cell and FIG. 4B is a cross-sectional view of a co-supported electrochemical cell, according to various embodiments of the present disclosure.

### DETAILED DESCRIPTION

As set forth herein, various aspects of the disclosure are described with reference to the exemplary embodiments and/or the accompanying drawings in which exemplary embodiments of the invention are illustrated. This invention may, however, be embodied in many different forms and should not be construed as limited to the exemplary embodiments shown in the drawings or described herein. It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

Ranges can be expressed herein as from “about” one particular value, and/or to “about” another particular value. When such a range is expressed, the range may include endpoints of the range. Similarly, when values are expressed as approximations, by use of the antecedent “about” or “substantially” it will be understood that the particular value forms another aspect. In some embodiments, a value of “about X” may include values of +/−1% X. It will be further understood that the endpoints of each of the ranges are significant both in relation to the other endpoint, and independently of the other endpoint.

Electrochemical cell systems include fuel cell and electrolyzer cell systems. In a high temperature fuel cell system, such as a solid oxide fuel cell (SOFC) system, an oxidizing flow is directed to the cathode side of the fuel cell while a fuel (e.g., hydrogen, ammonia or hydrocarbon fuel) flow is directed to the anode side of the fuel cell. The oxidizing flow is typically air, while the fuel flow can be hydrogen (H₂) or a hydrocarbon fuel, such as methane, natural gas, ethanol, or methanol, or a hydrogen containing fuel such as ammonia. The fuel cell, operating at a typical temperature between 750 °C and 950 °C, enables the transport of negatively charged oxygen ions from the cathode flow stream to the anode flow stream, where the ions combine with either free hydrogen or hydrogen in a hydrocarbon molecule to form water vapor and/or with carbon monoxide to form carbon dioxide. The excess electrons from the negatively charged ions are routed back to the cathode side of the fuel cell through an electrical circuit completed between the anode and the cathode, resulting in an electrical current flow through the circuit.

In an electrolyzer system, such as a solid oxide electrolyzer system (SOEC), a fuel flow comprising water (e.g., steam) is separated into hydrogen and oxygen by applying a voltage across the electrolyzer cells. In the SOEC stack, the anode is the air electrode and the cathode is the fuel electrode. Thus, the electrode to which the fuel (e.g., hydrogen, ammonia or hydrocarbon fuel in a SOFC, and steam in a SOEC) is supplied may be referred to as the fuel electrode and the opposing electrode may be referred to as the air electrode in both SOFC and SOEC cells.

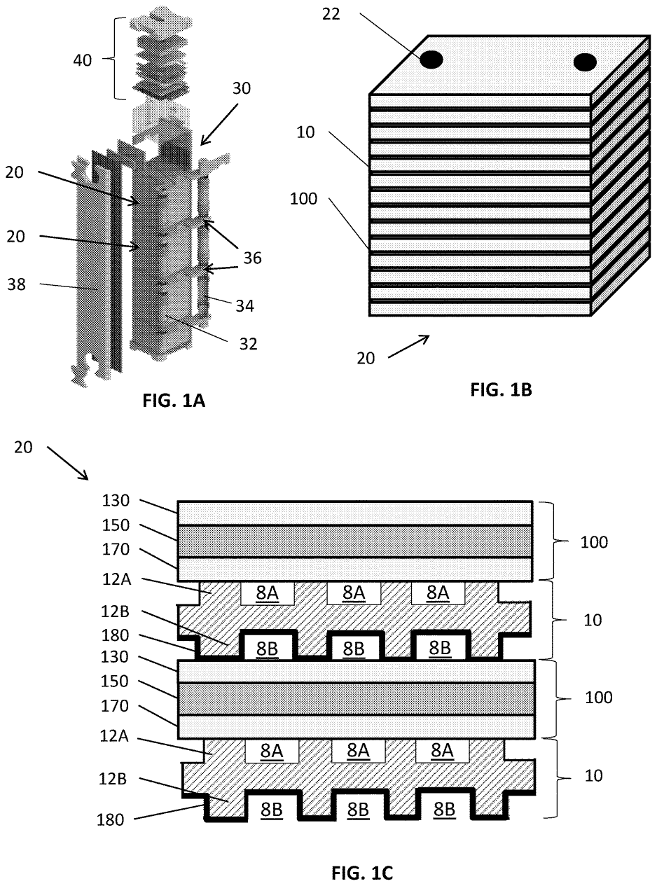

FIG. 1A is a perspective view of an electrochemical cell column 30, FIG. 1B is a perspective view of one solid oxide electrochemical cell (e.g., SOFC or SOEC) stack 20 included in the column 30 of FIG. 1A, and FIG. 1C is a side cross-sectional view of a portion of the stack 20 of FIG. 1B.

Referring to FIGS. 1A and 1B, the column 30 may include one or more electrochemical cell stacks 20, a fuel inlet conduit 32, a fuel exhaust conduit 34, and fuel feed/return assemblies 36 (e.g., anode splitter plates (ASPs) 36). The column 30 may also include side baffles 38 and a compression assembly 40. The fuel inlet conduit 32 is fluidly connected to ASPs 36 and is configured to provide the fuel feed to each ASP 36, and fuel exhaust conduit 34 is fluidly connected to ASPs 36 and is configured to receive fuel exhaust from each ASP 36.

The ASPs 36 are disposed between the stacks 20 and are configured to provide a fuel (e.g., hydrogen, ammonia or hydrocarbon fuel or steam) feed to the stacks 20 and to receive fuel exhaust from the SOFC stacks 20 or a hydrogen product stream from the SOEC stacks 20. For example, the ASPs 36 may be fluidly connected to internal fuel holes 22 formed in the stacks 20, as discussed below. In some configurations, an ASP 36 may be disposed at one end of the column 30 to provide a fuel to one of the stacks 20 located at one end of the column 30.

Referring to FIG. 1C, the stack 20 includes multiple electrochemical cells 100 that are separated by interconnects 10, which may also be referred to as gas flow separator plates or bipolar plates. Each electrochemical cell 100 includes an air electrode 130, a solid oxide electrolyte 150, and a fuel electrode 170.

Each interconnect 10 electrically connects adjacent electrochemical cells 100 in the stack 20. In particular, an interconnect 10 may electrically connect the fuel electrode 170 of one electrochemical cell 100 to the air electrode 130 of an adjacent electrochemical cell 100. FIG. 1C shows that the lower electrochemical cell 100 is located between two interconnects 10.

Each interconnect 10 may be made of or may contain electrically conductive material, such as a metal alloy (e.g., chromium-iron alloy) which has a similar coefficient of thermal expansion to that of the solid oxide electrolyte in the cells (e.g., a difference of 0-10%). For example, the interconnects 10 may each include a metallic substrate comprising a high-temperature stable metal alloy, such as a chromium-iron alloy, such as 4-6 weight percent (“wt %”) iron, optionally 1 or less weight percent yttrium, and a balance of chromium. Alternatively, any other suitable conductive interconnect material, such as stainless steel (e.g., ferritic stainless steel, SS446, SS430, etc.) or iron-chromium alloy (e.g., Crofer® 22 APU alloy which contains 20 to 24 wt % Cr, less than 1 wt % Mn, Ti and La, and balance Fe, or ZMG® 232 L alloy which contains 21 to 23 wt % Cr, 1 wt % Mn and less than 1 wt % Si, C, Ni, Al, Zr and La, and balance Fe) may be used.

Each interconnect 10 includes fuel ribs 12A that at least partially define fuel channels 8A and air ribs 12B that at least partially define the air channels 8B. The interconnect 10 may operate as a gas-fuel separator that separates a fuel flowing to the fuel electrode 170 of one cell in the stack from oxidant, such as air, flowing to the air electrode 130 of an adjacent cell in the stack. At either end of the stack 20, there may be an air end plate or fuel end plate (not shown) for providing air or fuel, respectively, to the end electrode in the stack. Alternatively, the same interconnect 10 may be used as an air end plate or fuel end plate.

An electrically conductive contact layer, such as a nickel layer or mesh, may be provided between anode electrodes 170 and a fuel side of each interconnect 10. An optional protective layer 180 may be provided on at least an air side of each interconnect 10. The protective layer 180 may be configured to decrease the growth rate of a chromium oxide surface layer on the interconnect 10 and to suppress evaporation of chromium vapor species which can poison the electrochemical cell air electrode. Typically, the protective layer 180 may comprise a perovskite such as lanthanum strontium manganite (LSM) and may be formed using a spray coating or dip coating process. Alternatively, other metal oxide coatings such as a spinel material, such as an (Mn, Co)₃O₄ (MCO), can be used instead of or in addition to LSM. Any spinel having the composition Mn₂₋ₓCo₁₊ₓO₄ (0≤x≤1) or written as z(Mn₃O₄)+(1−z) (Co₃O₄), where (⅓≤z≤⅔) or written as (Mn, Co)₃O₄ may be used. In other embodiments, a mixed layer of LSM and MCO, or a stack of LSM and MCO layers may be used as the protective layer 180.

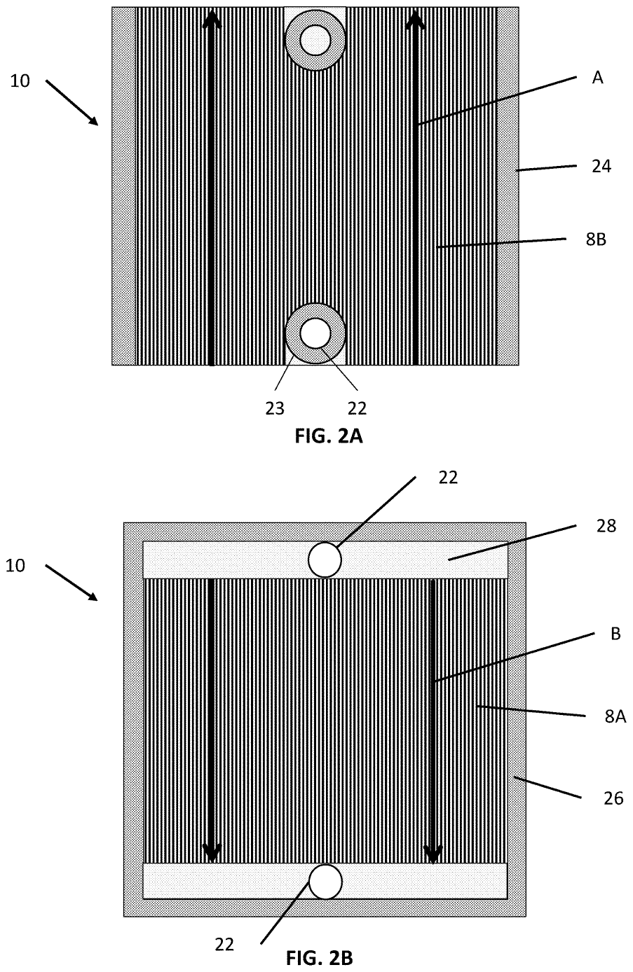

FIG. 2A is a top view of the air side of a counter-flow or co-flow interconnect 10, and FIG. 2B is a top view of a fuel side of the interconnect 10. Referring to FIGS. 1C and 2A, the air side includes the air channels 8B. Air flows through the air channels 8B to an air electrode 130 of an adjacent electrochemical cell 100. In particular, the air may flow across the interconnect 10 in a first direction A as indicated by the arrows.

Ring seals 23 may surround the fuel holes 22 of the interconnect 10, to prevent a fuel, such as a fuel or steam, from contacting the air electrode 130. Peripheral strip-shaped seals 24 are located on peripheral portions of the air side of the interconnect 10. The seals 23, 24 may be formed of a glass material. The peripheral portions may be in the form of an elevated plateau which does not include ribs or channels. The surface of the peripheral regions may be coplanar with tops of the air ribs 12B.

Referring to FIGS. 1C and 2B, the fuel side of the interconnect 10 may include the fuel channels 8A and fuel manifolds 28 (e.g., fuel plenums). A fuel such as a fuel or steam flows from one of the fuel holes 22, into the adjacent manifold 28, through the fuel channels 8A, and to a fuel electrode 170 of an adjacent electrochemical cell 100. Excess fuel may flow into the other fuel manifold 28 and then into the adjacent fuel hole 22. In particular, the fuel may flow across the interconnect 10 in a second direction B, as indicated by the arrows. The second direction B may be opposite to the first direction A (see FIG. 2A) referred to as a counter-flow design, or in the same direction as first direction A referred to as co-flow design.

A frame-shaped seal 26 is disposed on a peripheral region of the fuel side of the interconnect 10. The peripheral region may be an elevated plateau which does not include ribs or channels. The surface of the peripheral region may be coplanar with tops of the fuel ribs 12A.

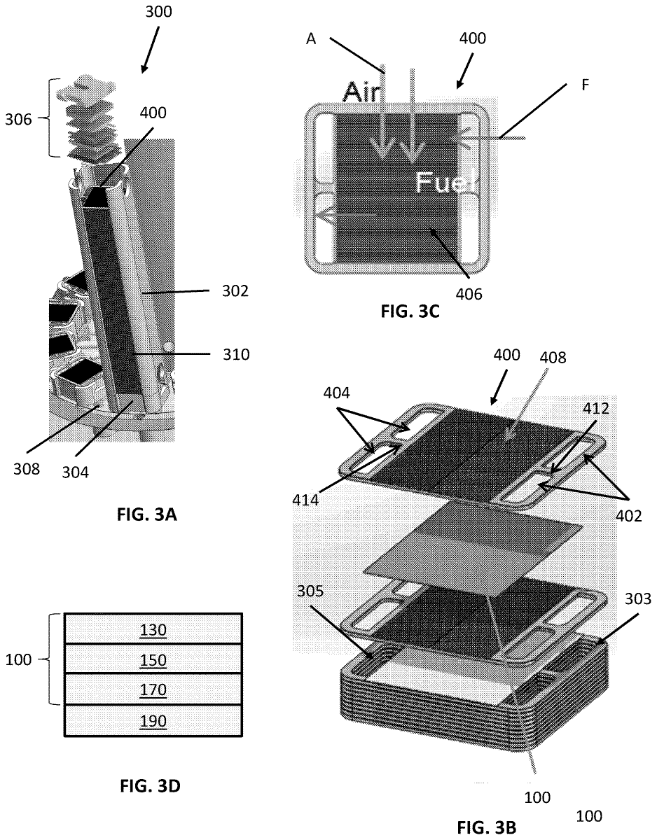

FIG. 3A is a perspective view of an internally manifolded cross-flow electrochemical cell column 300, according to various embodiments of the present disclosure, FIG. 3B is an exploded perspective view of a portion of the column 300 of FIG. 3A, FIG. 3C is a top view of the fuel side of an interconnect 400 included in the column 300, and FIG. 3D is a schematic view of an electrochemical cell included in the column 300.

Referring to FIGS. 3A-3D, the cell column 300, which may also be referred to as an electrochemical cell stack because it lacks ASPs, includes multiple electrochemical cells 100 (e.g., fuel cells or electrolyzer cells) that are separated by interconnects 400, which may also be referred to as gas flow separator plates or bipolar plates. One or more columns 300 may be thermally integrated with other components of an electrochemical cell system (e.g., one or more anode tail gas oxidizers, fuel reformers, fluid conduits and manifolds, etc. of a SOFC or SOEC system) in a common enclosure or “hotbox.”

Each electrochemical cell 100 may include a solid oxide electrolyte 150, a fuel electrode 170, and an air electrode 130. In some embodiments, the fuel electrode 170 and the air electrode 130 may be printed on the electrolyte 150. In other embodiments, a conductive layer 190, such as a nickel mesh, may be disposed between the fuel electrode 170 and an adjacent interconnect 400. The electrochemical cell 100 does not include through holes, such as the fuel holes described above.

The interconnects 400 are made from an electrically conductive metal alloy. An upper most interconnect 400 and a lowermost interconnect 400 of the column 300 may be different ones of an air end plate or fuel end plate including features for providing air or fuel, respectively, to an adjacent end electrochemical cell 100 in the stack 300. As used herein, an “interconnect” may refer to either an interconnect located between two electrochemical cells 100 or an end plate located at an end of the stack and directly adjacent to only one electrochemical cell 100. Since the column 300 does not include ASPs and the end plates associated therewith, the column 300 may include only two end plates.

The column 300 may include side baffles 302, a fuel plenum 304, and a compression assembly 306. The side baffles 302 may be formed of a ceramic material and may be disposed on opposing sides of the cell column 300 containing stacked electrochemical cells 100 and interconnects 400. The side baffles 302 may connect the fuel plenum 304 and the compression assembly 306, such that the compression assembly 306 may apply pressure to the column 300. The side baffles 302 may be curved baffle plates, such that each baffle plate covers at least portions of three sides of the cell column 300. For example, one baffle plate may fully cover the fuel inlet riser side of the column 300 and partially cover the adjacent front and back sides of the stack, while the other baffle plate fully may cover the fuel outlet riser side of the stack and partially cover the adjacent portions of the front and back sides of the stack. The remaining uncovered portions for the front and back sides of the stack allow air to flow through the column 300. The fuel plenum 304 may be disposed below the column 300 and may be configured to provide a hydrogen-containing fuel feed to the column 300 and may receive a fuel exhaust from the column 300. The fuel plenum 304 may be connected to fuel inlet and outlet conduits 308 which are located below the fuel plenum 304.

Each interconnect 400 electrically connects adjacent electrochemical cells 100 in the column 300. In particular, an interconnect 400 may electrically connect the fuel electrode 170 of one electrochemical cell 100 to the air electrode 130 of an adjacent electrochemical cell 100. As shown in FIG. 3C, each interconnect 400 may be configured to channel air in a first direction A, such that the air may be provided to the air electrode 130 of an adjacent electrochemical cell 100. Each interconnect 400 may also be configured to channel fuel in a second direction F, such that the fuel may be provided to the fuel electrode 170 of an adjacent electrochemical cell 100. Directions A and F may be perpendicular, or substantially perpendicular. As such, the interconnects 400 may be referred to as cross-flow interconnects.

The interconnect 400 may include through-holes configured for fuel distribution. For example, the interconnects 400 may include one or more fuel inlets 402 and one or more fuel outlets 404, which may also be referred to as fuel exhaust outlets 404. The fuel inlets and outlets 402, 404 may be disposed outside of the perimeter of the electrochemical cells 100. As such, the electrochemical cells 100 may be formed without corresponding through holes for fuel flow. The combined length of the fuel inlets 402 and/or the combined length of the fuel outlets 404 may be at least 75% of a corresponding length of the interconnect 400, e.g., a length taken in direction A.

In one embodiment, each interconnect 400 contains two fuel inlets 402 separated by a neck portion 412 of the interconnect 400, as shown in FIG. 3B. However, more than two fuel inlets 402 may be included, such as three to five inlets separated by two to four neck portions. In one embodiment, each interconnect 400 contains two fuel outlets 404 separated by a neck portion 414 of the interconnect 400, as shown in FIG. 3B. However, more than two fuel outlets 404 may be included, such as three to five outlets separated by two to four neck portions 414. Although not illustrated, the number of fuel inlets and fuel outlets can be different. The fuel inlets 402 and outlets 404 may be fluidly connected by fuel channels 406 that extend on the fuel side of the interconnect 400. Air channels 408 may be disposed on an opposing air side of the interconnect 400.

The fuel inlets 402 of adjacent interconnects 400 may be aligned in the column 300 to form one or more fuel inlet risers 303. The fuel outlets 404 of adjacent interconnects 400 may be aligned in the column 300 to form one or more fuel outlet risers 305. The fuel inlet riser 303 may be configured to distribute fuel received from the fuel plenum 304 to the electrochemical cells 100. The fuel outlet riser 305 may be configured to provide fuel exhaust received from the electrochemical cells 100 to the fuel plenum 304.

The side baffles 302 may optionally be curved around edges of the interconnects 400. In particular, the side baffles 302 may be disposed around the fuel inlets 402 and outlets 404 of the interconnects 400. Accordingly, the side baffles may more efficiently control air flow through air channels of the interconnects 400, which are exposed between the side baffles 302. In various embodiments, the column 300 may include from 200 to 400 electrochemical cells, such as 250 to 350 electrochemical cells, more particularly from 275 to 325 electrochemical cells, which may be provided with fuel using only the fuel risers 303, 305.

Each interconnect 400 may be made of or may contain electrically conductive material, such as a metal alloy which has a similar coefficient of thermal expansion to that of the solid oxide electrolyte in the cells (e.g., a difference of 0-10%).

Electrochemical cells, such as SOFCs and SOECs, are typically supported in order to increase mechanical stability and reliability. For example, solid oxide electrochemical cells include electrode-supported cells, electrolyte-supported cells, and co-supported cells. Electrolyte-supported cells include a relatively thick electrolyte upon which relatively thin electrodes are formed. Electrode supported cells include a relatively thick supporting electrode (e.g., fuel electrode, such as the anode for a SOFC) to provide structural support, and co-supported cells may include a relatively thick supporting electrode and a relatively thick electrolyte.

Electrode-supported SOFCs and SOECs are typically produced by co-sintering a support electrode material and an overlying electrolyte material. Electrode-supported cells include fuel electrode supported cells (e.g. anode-supported SOFCs and cathode-supported SOECs) having a relatively thick fuel electrode (e.g., anode for SOFCs and cathode of SOECs). As used herein, fuel electrode supported SOFCs and SOECs may also be referred to as “anode supported cells” using the conventional term in the art even though the fuel electrode functions as a cathode electrode in a SOEC.

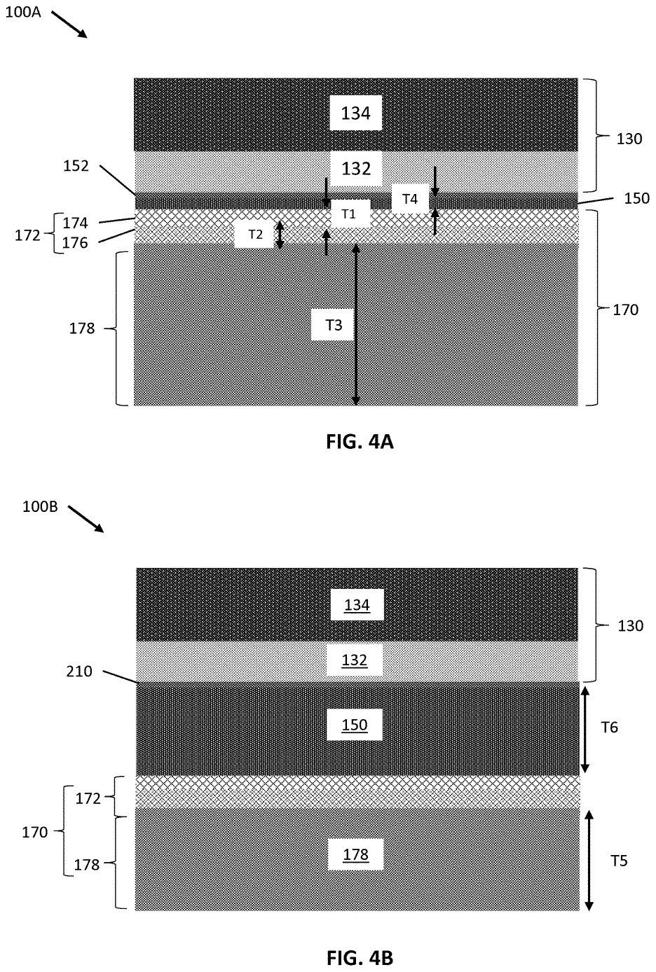

FIG. 4A is a cross-sectional view of a fuel electrode supported solid oxide electrochemical cell 100A and FIG. 4B is a cross-sectional view of a co-supported solid oxide electrochemical cell 100B, according to various embodiments of the present disclosure.

Referring to FIGS. 4A-4B, the solid oxide electrochemical cells 100A and 100B may include an electrolyte 150, a fuel electrode 170 located on a fuel side of the electrolyte 150, and an air electrode 130 located on an air side of the electrolyte 150.

In one embodiment, the electrolyte 150 may be formed of ytterbia-ceria-scandia-stabilized zirconia (YbCSSZ) in which scandia may be present in an amount equal to 9 to 11 mol %, such as 10 mol %, ceria may present in amount greater than 0 and equal to or less than 3 mol %, for example 0.5 mol % to 2.5 mol %, such as 1 mol %, and ytterbia may be present in an amount greater than 0 and equal to or less than 2.5 mol %, for example 0.5 mol % to 2 mol %, such as 1 mol %, as disclosed in U.S. Pat. No. 8,580,456, which is incorporated herein by reference.

The electrolyte 150 may optionally include a barrier layer 152 disposed on the air side of the electrolyte. The barrier layer 152 may be configured to prevent diffusion of air electrode materials into the electrolyte 150. The barrier layer 152 may comprise yttria stabilized zirconia, scandia and yttria stabilized zirconia, or samaria doped ceria.

The air electrode 130 may be disposed over the barrier layer 152 (if present). The air electrode 130 may be a single or multi-layer structure. For example, the air electrode 130 may include an air electrode functional layer 132 and a current collector layer (CCL) 134. The functional layer 132 may include an air side catalyst, such as lanthanum strontium manganate, lanthanum strontium cobaltite, lanthanum strontium cobalt ferrite or lanthanum nickel ferrite. The functional layer 132 may also optionally include an additional ceramic phase, such as a doped ceria phase, for example a samaria doped ceria or a gadolinia doped ceria. The CCL 134 may be composed of an electrically conductive material, such as a conductive perovskite material, for example, lanthanum strontium manganate or lanthanum strontium cobalt ferrite.

The fuel electrode170 may include a fuel electrode functional layer 172 located over the fuel side of the electrolyte 150 and a fuel electrode support 178 located over the functional layer 172. The fuel electrode functional layer 172 may include a nickel containing phase and an ionically conductive doped ceria ceramic phase, such as gadolinia doped ceria (GDC) or samaria doped ceria (SDC). In some embodiments, the nickel containing phase may include an optional additional metal dopant to improve phase stability and/or redox tolerance.

The fuel electrode functional layer 172 may be a single or multi-layer structure. In one embodiment, the functional layer 172 may include a first functionally graded (FG) layer 174 and a second FG layer 176. The first FG layer 174 may include a lower ratio of the nickel containing phase to the ionically conductive phase than the second FG layer 176.

The first FG layer 174 may have a thickness T1 ranging from about 4 μm to about 15 μm, such as from about 5 μm to about 10 μm. The second FG layer 176 may have a thickness T2 ranging from about 4 μm to about 15 μm, such as from about 5 μm to about 10 μm. However, the present disclosure is not limited to any particular FG layer thicknesses.

As shown in FIG. 4A, in the fuel electrode supported electrochemical cell 100A, the fuel electrode support 178 may have a thickness T3 ranging from about 200 μm to about 500 μm, such as from about 300 μm to about 400 μm. The electrolyte 150 may have a thickness T4 ranging from about 4 μm to about 15 μm, such as from about 5 μm to about 10 μm. Accordingly, the relatively thick fuel electrode support 178 may support the relatively thin electrolyte 150.

As shown in FIG. 4B, the co-supported electrochemical cell 100B may include a relatively thin fuel electrode support 178 and a relatively thick electrolyte 150 compared to the fuel electrode supported electrochemical cell 100A. In particular, the fuel electrode support 178 may have a thickness T5 ranging from about 20 μm to about 100 μm, such as from about 25 μm to about 75 μm, or from about 40 μm to about 60 μm. The electrolyte 150 may have a thickness T6 ranging from about 20 μm to about 80 μm, such as from about 30 μm to about 70 μm, from about 40 μm to about 60 μm, or about 50 μm. The relatively thick electrolyte 150 may be self-supporting. As such, the thickness of the fuel electrode support 178 of the cell 100B may be reduced, as compared to the fuel electrode support 178 of the cell 100A, without compromising cell strength.

In conventional fuel electrode supported electrochemical cells, YSZ is the typical material for both the fuel electrode support and the fuel electrode functional layer ceramic phase. However, the conventional Ni-YSZ cermet functional layers located within about 15 microns of the fuel side of the electrolyte typically require a Ni percolation which corresponds to at least about 25% nickel by volume to achieve desirable electrochemical performance because YSZ has a very low electrical conductivity. Thus, the conventional fuel electrode design depends on Ni for both electrocatalysis and electrical conductivity, and depends on YSZ for ionic conductivity, and includes densely packed electrodes to maximize the catalytically active sites at the triple junctions of Ni, YSZ, and gas phases.

Mixed ionic-electronic conductor (MIEC) ceramic materials, such as doped ceria, have a higher electrical conductivity than YSZ. However, doped ceria forms ionically resistive interphases with conventional zirconia based electrolytes (e.g., YSZ or SSZ) during typical YSZ or SSZ electrolyte sintering at high temperatures above 1300 °C, such as 1350 to 1400 °C. Therefore, conventional solid oxide electrochemical cells which include YSZ or SSZ electrolyte and a doped ceria fuel electrode are formed as electrolyte supported cells. In an electrolyte supported cell, the YSZ or SSZ electrolyte is sintered first at high temperatures above 1300 °C, followed by deposition of the fuel electrode on the sintered electrolyte and fuel electrode sintering at a temperature below 1300 °C, such as at 1100 to 1250 °C, to avoid formation of the ceria-zirconia ionically resistive interphases at sintering temperatures above 1300 °C.

In contrast, fuel electrode supported cells and co-supported cells are manufactured by forming the electrolyte on the fuel electrode followed by sintering the electrolyte (separately or together with the fuel electrode). Thus, in a conventional fuel electrode supported cell or a co-supported cell, both the electrolyte and the fuel electrode are either zirconia based or ceria based to avoid formation of the ionically resistive interphases during the high temperature electrolyte sintering while the electrolyte contacts the fuel electrode.

The zirconia based fuel electrodes suffer from low electrical conductivity and require a high volume percent of nickel adjacent to the electrolyte, as described above. During cell shutdown, oxygen influx into the fuel electrode rapidly oxidizes the nickel phase of the fuel electrode. The resultant nickel oxide may generate a nickel phase volume increase of 70% or more. Without sufficient fuel electrode porosity, this nickel phase expansion may fracture the fuel electrode and/or electrolyte of the conventional electrochemical cell, which may lead to cell failure. Thus, the zirconia based fuel electrodes suffer from poor redox tolerance.

In contrast, if both the electrolyte and the fuel electrode of a fuel electrode supported cell are formed from a doped ceria, then the cell suffers from a relatively high power loss due to leakage current flow through the electrolyte arising from the relatively high electrical conductivity of the doped ceria electrolyte.

The present inventors realized that the YbCSSZ electrolyte material may be sintered to achieve a full dense electrolyte layer 150 at a relatively low temperature (e.g., below 1300 °C) at which the ionically resistive interphases do not form between adjacent zirconia and doped ceria layers. Therefore, embodiments of the present disclosure provide a method of forming a fuel electrode supported (or co-supported) solid oxide electrochemical cell which includes the zirconia based YbCSSZ electrolyte and the doped ceria based fuel electrode. Such cells have a higher redox tolerance than cells which contain a zirconia based fuel electrode, and a lower leakage current than cells which contain a doped ceria electrolyte.

In various embodiments, in the solid oxide electrochemical cells 100, such as electrochemical cells 100A and 100B shown in FIGS. 4A-4B, the electrolyte layer 150 may comprise the zirconia based YbCSSZ which contains more than 50 molar percent zirconia. In particular, the YbCSSZ material may comprise a 1Yb1Ce10ScSZ (i.e., 1 mol % ytterbia, 1 mol % cera, 10 mol % scandia and balance zirconia).

The fuel electrode functional layer 172 may comprise a nickel containing phase and an ionically conductive ceramic phase that comprises a doped ceria mixed ionic-electronic conductor (MIEC) material. For example, doped ceria materials may include gadolinia, yttria and/or samaria doped ceria materials, such as samaria-doped ceria (SDC). In some embodiments, the SDC material may comprise Sm_{0.2}Ce_{0.8}O₂. In other words, the fuel electrode functional layer 172 may comprise a Ni-SDC cermet material. The nickel containing phase may include metallic nickel or nickel oxide, depending whether the fuel electrode functional layer 172 is in a reduced or oxidized state. For example, the nickel containing phase may be deposited as nickel oxide (e.g., NiO), and then reduced to metallic nickel by an anneal in a reducing ambient after sintering the electrolyte layer 150 and the fuel electrode functional layer 172. The nickel phase may optionally include dopants to improve phase stability and/or redox tolerance. The ceramic phase contains at least 50 molar percent doped ceria, such as 90 to 100 molar percent doped ceria.

For example, the first FG layer 174 may comprise from 15 wt. % to 35 wt. % of the nickel phase, and from 65 wt. % to 85 wt. % of the doped ceria phase. In some embodiments, the first FG layer 174 may include less than 25 wt. %, such as 15 to 20 wt. % of the nickel phase and 80 to 85 wt. % of the doped ceria phase. The second FG layer 176 may comprise from 60 wt. % to 85 wt. %, such as from 65 wt. % to 80 wt. %, of the nickel phase and from 15 wt. % to 40 wt. %, such as from 20 wt. % to 35 wt. % of the SDC phase. Accordingly, the second FG layer 176 may have a higher nickel loading than the first FG layer 174.

The fuel electrode support 178 may comprise a nickel cermet, such as a nickel-YSZ or a nickel-doped ceria cermet. Since the fuel electrode support 178 is located distal from the electrolyte layer 150, the inclusion of the YSZ ceramic phase would not significantly affect the redox tolerance of the cell 100.

According to various embodiments, the electrochemical cell 100 (e.g., the fuel electrode supported cell 100A or the co-supported cell 100B) may be fabricated by depositing a second FG layer 176 on the fuel electrode support 178, depositing a first FG layer 174 on the second FG layer 176, and then depositing an electrolyte layer 150 on the first FG layer 174 to form a stacked structure.

The fuel electrode support 178 may be formed by tape casting or the like. In one embodiment, the first FG layer 174 and the second FG layer 176 may be formed by depositing inks that include cermet powders having desired nickel containing phase to ceramic phase ratios dispersed in a liquid phase. Specifically, the cermet powders comprise cermet powder particles that each include both the nickel containing phase (e.g., NiO) and the ceramic phase (e.g., doped ceria, such as SDC). For example, each powder particle may comprise a NiO-SDC cermet powder particle having a desired NiO:SDC weight ratio for the first and second FG layers. The NiO:SDC weight ratio may be lower in the cermet powder particles used to form the first FG layer 174 than the cermet powder particles used to form the second FG layer 176. The cermet powder particles may be formed by a co-synthesis process, such as combustion spray pyrolysis or co-precipitation. In some embodiments, inks comprising the corresponding cermet powders may be deposited on the fuel electrode support 178 by screen printing, lamination, sequential tape casting, slot die coating, or the like, to form the FG layers 174, 176. The electrolyte layer 150 may be formed by depositing a corresponding ink on the first FG layer 174 using a similar printing or coating process. In various embodiments, the electrolyte layer 150 may be formed using an ink comprising powder particles of the YbCSSZ material, such as 1Yb1Ce10ScSZ, dispersed in a liquid phase.

The electrolyte layer 150 (e.g., the stacked structure containing the electrolyte layer 150) may be sintered at a temperature below 1300 °C, such as a temperature ranging from 1100 °C to 1250 °C, such as from 1150 °C to 1200 °C to form a fully dense YbCSSZ electrolyte layer 150. As such, the fuel electrode support 178, the fuel electrode functional layer 172, and the electrolyte layer 150 may be co-sintered at a relatively low temperature without forming the ionically resistive phases due to the reaction between the zirconia based electrolyte layer 150 and the functional layer 172 including the doped ceria based ceramic phase.

The air electrode 130 may be deposited on the sintered stacked structure and then sintered at a temperature below 1300 °C, such as a temperature ranging from 1000 °C to 1200 °C, to form an electrochemical cell 100 (e.g., the fuel electrode supported solid oxide electrochemical cell 100A or the co-supported solid oxide electrochemical cell 100B). For example, the air electrode functional layer 132 may be formed by printing or coating a first ink on the electrolyte layer 150. A CCL 134 may be formed by printing or coating a second ink on the air electrode functional layer 132. The electrochemical cell 100 may be sintered at a lower temperature than the stacked structure. For example, the resultant structure may be sintered at a temperature may range from 1000 °C to 1200 °C, such as from 1050 °C to 1150 °C.

In an alternative embodiment, the air electrode 130 may be formed on the electrolyte layer 150 prior to firing the stacked structure. The resultant electrochemical cell 100 may be co-sintered in a single step, at a temperature below 1300 °C, such as a temperature ranging from 1100 °C to 1250 °C, such as from 1150 °C to 1200 °C.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

What is claimed is:

1. A method of forming a fuel electrode supported or co-supported solid oxide electrochemical cell, the method comprising:
depositing a fuel electrode functional layer comprising a nickel containing phase and a doped ceria ceramic phase over a fuel electrode support;
depositing an electrolyte layer comprising a ytterbia-ceria-scandia-stabilized zirconia (YbCSSZ) material over the fuel electrode functional layer;
sintering the electrolyte layer at a first temperature below 1300 °C; and
forming an air electrode on the electrolyte layer.

2. The method of claim 1, wherein the step of sintering the electrolyte layer occurs prior to forming the air electrode on the electrolyte layer, and the step of sintering the electrolyte layer also sinters the fuel electrode functional layer.

3. The method of claim 2, wherein the step of forming the air electrode comprises:
depositing an air electrode functional layer over the sintered electrolyte layer;
depositing a current collector layer over the air electrode functional layer; and
sintering the air electrode functional layer and the current collector layer at second temperature below 1300 °C.

4. The method of claim 1, wherein the step of sintering the electrolyte layer occurs after forming the air electrode on the electrolyte layer, and the step of sintering the electrolyte layer also sinters the fuel electrode functional layer and the air electrode.

5. The method of claim 4, wherein the step of forming the air electrode comprises:
depositing an air electrode functional layer over the electrolyte layer prior to the step of sintering the electrolyte layer;
depositing a current collector layer over the air electrode functional layer; and
sintering the electrolyte layer, the fuel electrode functional layer, the air electrode functional layer and the current collector layer at the first temperature below 1300 °C.

6. The method of claim 1, wherein the step of depositing the fuel electrode functional layer comprises:
depositing a second functionally graded (FG) layer comprising the nickel containing phase and the doped ceria ceramic phase on the fuel electrode support; and
depositing a first FG layer comprising the nickel containing phase and the doped ceria ceramic phase on the first FG layer.

7. The method of claim 6, wherein:
the second FG layer has a higher nickel containing phase to the doped ceria ceramic phase ratio than the first FG layer; and
the nickel containing phase comprises NiO.

8. The method of claim 7, wherein:
the first FG layer comprises from 15 wt. % to 35 wt. % of the NiO and from 65 wt. % to 85 wt. % of the doped ceria ceramic phase; and
the second FG layer comprises from 60 wt. % to 85 wt. % of the NiO and from 15 wt. % to 40 wt. % of the doped ceria ceramic phase.

9. The method of claim 8, wherein the doped ceria ceramic phase comprises samaria doped ceria.

10. The method of claim 7, wherein:
the step of depositing the second FG layer comprises printing a second ink comprising co-synthesized second NiO-doped ceria cermet particles; and
the step of depositing the first FG layer comprises printing a first ink comprising co-synthesized first NiO-doped ceria cermet particles.

11. The method of claim 7, further comprising reducing the NiO to metallic nickel after the step of sintering the electrolyte layer.

12. The method of claim 1, wherein the YbCSSZ material comprises 1Yb1Ce10ScSZ, and the fuel electrode support comprises a nickel cermet material.

13. The method of claim 1, further comprising placing the fuel electrode supported or co-supported solid oxide electrochemical cell into an electrochemical cell stack comprising a plurality of interconnects and a plurality of solid oxide electrochemical cells.

14. The method of claim 1, wherein the first temperature ranges from 1100 °C to 1250 °C.

15. The method of claim 14, wherein the first temperature ranges from 1150 °C to 1200 °C.

16. The method of claim 1, wherein the fuel electrode supported or co-supported solid oxide electrochemical cell comprises a fuel electrode supported or co-supported solid oxide fuel cell.

17. The method of claim 1, wherein the fuel electrode supported or co-supported solid oxide electrochemical cell comprises a fuel electrode supported or co-supported solid oxide electrolyzer cell.

18. The method of claim 1, wherein the fuel electrode supported or co-supported solid oxide electrochemical cell comprises the fuel electrode supported solid oxide electrochemical cell.

19. The method of claim 18, wherein:
the fuel electrode support has a thickness ranging from 300 μm to 400 μm;
the electrolyte layer has a thickness ranging from 5 μm to 10 μm; and
the fuel electrode functional layer has a thickness ranging from 10 μm to 20 μm.

20. The method of claim 1, wherein the fuel electrode supported or co-supported solid oxide electrochemical cell comprises the co-supported solid oxide electrochemical cell.
